(19) United States
(12) Patent Application Publication
(10) Pub. No.: US 2016/0300177 A1
(43) Pub. Date: Oct. 13, 2016

(54) IMPLEMENTATION-EMBEDDED AND RUNTIME-RELEVANT BUSINESS PROCESS MODELING

(71) Applicant: SAP SE, Wallforf (DE)

(72) Inventors: Martin Wilmes, Oftersheim (DE); Bernhard Thimmel, Edingen-Neckarhausen (DE); Renzo Colle, Stutensee (DE)

(21) Appl. No.: 14/682,655

(22) Filed: Apr. 9, 2015

(51) Int. Cl. G06Q 10/06

(52) U.S. Cl. CPC G06Q 10/06316; G06Q 10/067

(57) ABSTRACT

Embodiments of the present invention may provide a method for executing a business process. The method may include receiving a selection of a plurality of sub-process models, corresponding to sub-processes of the business process and selected from a library of standard sub-process models. The method may include receiving user specifications for one or more of the sub-process models, and modifying the sub-process models based on the user specifications. Subsequently, the method may include linking the sub-process models to create one or more process variants and one or more process flows of the business process, and generating, by one or more processors, software artifacts from the process variants. The method may further include executing the process variants, by the one or more processors, by combining dynamically one or more of the software artifacts, triggering one or more of the sub-process models to receive data resulting from the corresponding sub-processes being executed.

### FIELD OF THE INVENTION

The disclosure relates to business process modeling.

### BACKGROUND

A goal of a business application is to support a business owner in running a business process, which may include one or more sub-processes. The sub-processes are often interdependent. For example, one sub-process may not be able to start until a predecessor sub-process is completed, and the results of one sub-process may be inputs to one or more successor sub-processes. The interdependence among sub-processes tends to get more complex as the business grows and the number of sub-processes increases.

Some business applications, such as SAP™ Business ByDesign, have been successful in mapping an entire business domain into business documents, which can be referred to as business objects, and presenting one or more of the business objects to a user, who executes one of the sub-processes. The business objects contain data relevant to the sub-process, usually one or more tasks, to be executed by the user. The business objects give the user all the information that he needs to execute the task(s), and enable the collection of the results of the user's work.

The task of a single user may be embedded into a process flow that optimizes his work for the whole business. Therefore, the business objects may also contain results of predecessor sub-processes and inputs to successor sub-processes. Such embedding influences what the user of the task has to do. In other words, the user has to understand to some extent how his task is embedded into the whole process flow.

However, in current business applications, there is no common method of modeling and implementing the participation of a business object in several sub-processes and the overall process flow. Therefore, the knowledge of how a business object is used in and influenced by the overall process flow is embedded in the business object itself, including hard-coded implementation of all possible data flows and consistency checks. Consequently, the link of a given business object to the overall process flow may not be easily identified, and most business objects work with the assumptions that all possible successor sub-processes will run and that data being collected has to meet the consistency checks for all the possible successor sub-processes. Computing resources are clearly unnecessarily expensed.

Thus, there remains a need for business applications that not only allow users to enter business objects, but also describe the data flows that occur among the business objects and the conditions under which the data flows can occur.

### BRIEF DESCRIPTION OF THE DRAWINGS

FIG. 1 illustrates a system, according to an embodiment.

FIG. 2 illustrates process for modeling and executing a business process, according to an embodiment.

FIG. 3 illustrates a business process model, according to an embodiment.

FIG. 4 illustrates a process variant of the business process model in FIG. 3, according to an embodiment.

FIG. 5 illustrates a process variant of a sub-process model of FIG. 4, according to an embodiment.

FIG. 6 illustrates the process variant of FIG. 5 embedded in the process variant of FIG. 4, according to an embodiment.

FIG. 7 illustrates a process variant of a sub-process model of FIG. 5, according to an embodiment.

FIG. 8 illustrates the process variant of FIG. 7 embedded in the process variant of FIG. 5, which is embedded in the process variant of FIG. 4, according to an embodiment.

### DETAILED DESCRIPTION

Embodiments of the present invention may provide a method for executing a business process. The method may include receiving a selection of a plurality of sub-process models, corresponding to sub-processes of the business process and selected from a library of standard sub-process models. The method may include receiving user specifications for one or more of the sub-process models, and modifying the sub-process models based on the user specifications. Subsequently, the method may include linking the sub-process models to create one or more process variants and one or more process flows of the business process, and generating, by one or more processors, software artifacts from the process variants. The method may further include executing the process variants, by the one or more processors, by combining dynamically one or more of the software artifacts, triggering one or more of the sub-process models to receive data resulting from the corresponding sub-processes being executed.

Embodiments of the present invention provide a non-transitory machine-readable medium for storing instructions adapted to be executed by one or more processors to perform operations. The operations may include receiving a selection of a plurality of sub-process models, corresponding to sub-processes of the business process and selected from a library of standard sub-process models. The operations may include receiving user specifications for one or more of the sub-process models, and modifying the sub-process models based on the user specifications. Subsequently, the operations may include linking the sub-process models to create one or more process variants and one or more process flows of the business process, and generating, by one or more processors, software artifacts from the process variants. The operations may further include executing the process variants, by the one or more processors, by combining dynamically one or more of the software artifacts, triggering one or more of the sub-process models to receive data resulting from the corresponding sub-processes being executed.

Embodiments of the present invention provide an electronic device including one or more processors and memory storing instructions adapted to be executed by the one or more processors to perform operations. The operations may include receiving a selection of a plurality of sub-process models, corresponding to sub-processes of the business process and selected from a library of standard sub-process models. The operations may include receiving user specifications for one or more of the sub-process models, and modifying the sub-process models based on the user specifications. Subsequently, the operations may include linking the sub-process models to create one or more process variants and one or more process flows of the business process, and generating, by one or more processors, software artifacts from the process variants. The operations may further include executing the process variants, by the one or more processors, by combining dynamically one or more of the software artifacts, triggering one or more of the sub-process models to receive data resulting from the corresponding sub-processes being executed.

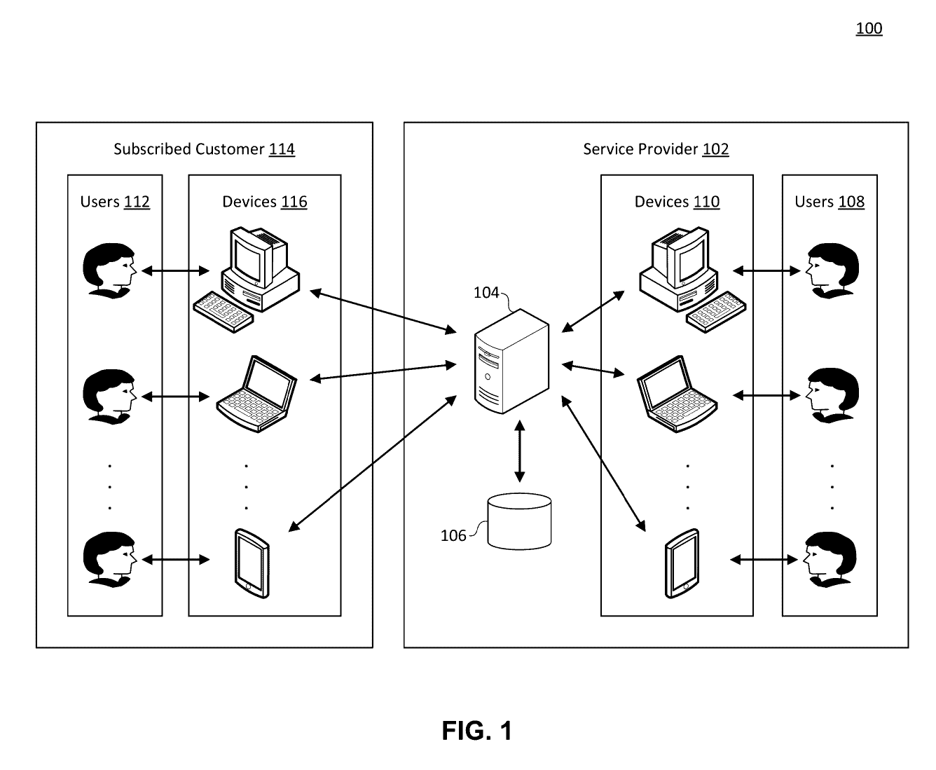

FIG. 1 illustrates a system 100, according to an embodiment. In the system 100, a business application may be hosted by a service provider 102 and installed on a server 104 maintained by service provider 102. The service provider 102 may also maintain a database system 106, connected to the server 104. The service provider 102 may include a plurality of users 108, who may access the business application through a plurality of devices 110, which may include, for example, a mobile device (e.g., a mobile phone or a smart phone), a personal computer, a tablet, a terminal device, or a personal digital assistant (PDA). A plurality of users 112 may belong to a subscribed business customer 114 of the service provider 102, and the users 112 may access the business application through a plurality of devices 116, which may include, for example, a mobile device (e.g., a mobile phone or a smart phone), a personal computer, a tablet, a terminal device, or a PDA. Each one of the users 112 may be assigned to a respective business role according to the business needs of the customer 114.

The business application may enable the implementation, modeling, execution, and monitoring of a business process of the customer 114. The business process may comprise a plurality of interdependent sub-processes. One skilled in the art would appreciate that each sub-process may also comprise a plurality of interdependent sub-processes, and that the level of granularity of modeling the business process may effectively be infinite.

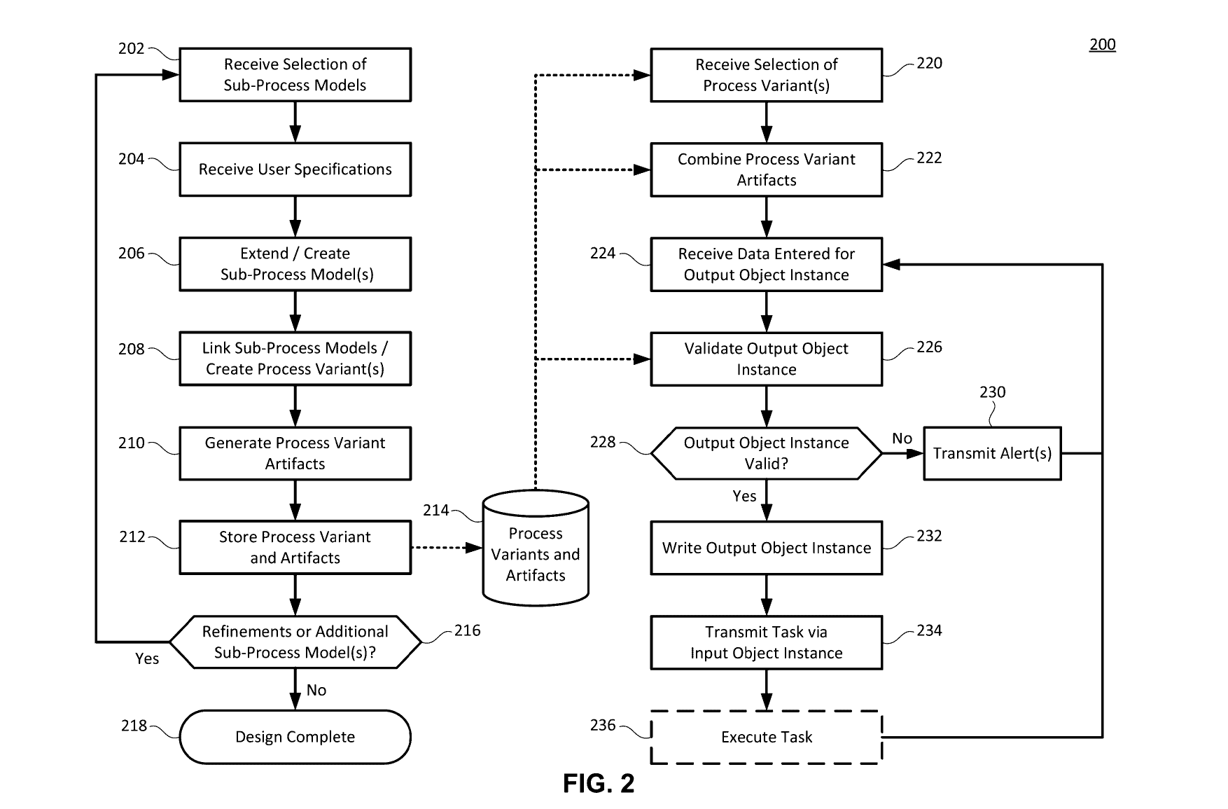

According to an example embodiment, FIG. 2 illustrates a process 200 for implementing, modeling, executing, and monitoring the business process of the customer 114 using the business application. In step 202, during a design period, the business application may receive, from one or more of the users 112, a selection of sub-process models corresponding to the sub-processes of the business process. An exemplary user, who is responsible for selecting the sub-process models, may be a process engineer of the customer 114. The process engineer may typically be someone who understands, defines, and models the complete business process of the customer 114. The process engineer may not necessarily work directly with the sub-processes or instances of business documents, also called business objects, which store data related to the sub-processes. However, the process engineer is typically knowledgeable about one or more process variants that bind instances of sub-processes and business objects to build a complete process flow of the business process of the customer 114. The process variants may represent the business process at different levels of granularity. An infinite number of process variants of the business process may exist. The process engineer may define the business process by defining a starting point and the sub-processes that are necessary to reach a goal of the business process.

The process engineer may select the sub-process models from a library of standard or template sub-process models. The standard sub-process models may have been implemented by one or more of the users 108—one or more developers at the service provider 102, for example. In this case, the users 108 may not have any information regarding the business process of the customer 114, but may be knowledgeable about several standard sub-processes that may be common to many customers, including the customer 114. Therefore, the process engineer may be responsible for understanding the standard sub-process models and choosing the standard sub-process models that fit or that may be extended/optimized to fit the actual sub-processes of the business process of the customer 114. The business application may provide the process engineer access to the library of standard sub-process models, which may be stored either on the server 104 or in the database system 106.

In step 204, during the design period, the business application may receive specifications about the business process from the users 112, including a process engineer. The process engineer may define and model the starting point, the sub-processes, process flows, and conditions under which the process flows may occur, to reach the goal of the business process. The process engineer may also model the differences between variants of process flows related to different process variants of the business process.

The process engineer may further identify sub-process models or sequences of sub-process models that may be reused as process variants of the sub-process of the business process. In other words, sub-processes that are executed in the same way may be modeled once, and the sub-process models may then be reused as needed as process variants of the business process. Reusing sub-process models may guarantee that tasks within the sub-processes are executed in the same way. The business application allowing the reuse of sub-process models or sequences of the sub-process models may help to simplify modeling overall business process and to keep the variety of process variants of the business process manageable. The process engineer may also identify sub-processes that cannot be modeled from the standard sub-process models from the library. These sub-processes may be modeled from scratch in the next step.

While the process engineer may model one or more process variants of the business process, there may be one or more sub-process engineers, among the users 112, focusing on further modeling one or more sub-processes of the business process at a deeper level of granularity. In other words, the sub-process engineer may model different process variants of the sub-processes. The sub-process engineer may typically understand in detail the tasks to be executed within the sub-processes, the prerequisites needed by the sub-processes, and the outcome from the tasks that needs to be recorded. Therefore, in step 204, the sub-process engineers may define the characteristics of the one or more sub-processes. The sub-process engineer may define at least the input data needed, the tasks to be executed, and the results to be recorded.

In step 206, during the design period, based on all the specifications received by the business application in step 204, either the users 108 or the users 112 may extend one or more of the selected standard sub-process models, to be tailored for the sub-processes of the customer 114. Extending the standard sub-process models may involve specifying format requirements and validity criteria for recorded data, and specifying the level of automation required to execute the sub-process models, including defining algorithms for the sub-process models. A sub-process model may be executed manually by one or more of the users 112, automatically, or partly manually and partly automatically. The developers may also create completely new sub-process models, if such sub-process models have been identified in step 204.

Once all the sub-process models have been extended or created accordingly, in step 208, during the design period, the business application may link the sub-process models to create one or more process variants and process flows of the business process and/or its sub-processes, as defined in step 204 by the process engineer, for example. There may be at least two types of process flows—an instance-triggering process flow and a data process flow. The instance-triggering process flow is a flow of output data from a predecessor sub-process model to one or more successor sub-process models, such that execution of the one or more sub-process models can begin. The data process flow is a flow of additional data from at least one of an earlier sub-process model and a business object to one or more successor sub-process models. The additional data may be data generated within a sub-process or part of initial data entered to start the business process.

In step 210, during the design period, the business application may generate software artifacts from the one or more process variants. The software artifacts may address the aspects of the process variants and may describe in meta-language what the process variants provide.

In step 212, the business application stores the process variants designed to represent the business process and/or the sub-processes of the customer 114, along with the corresponding generated software artifacts, into a repository 214. The repository 214 may reside either on the server 104 or in the database system 106 of the system 100, illustrated in FIG. 1. The business application may access the process variants and their corresponding software artifacts from the repository 214 at a later point during a runtime period, as will be discussed below.

In step 216, during the design period, the process 200 checks whether the users 112, usually a process engineer or a sub-process engineer, may need to refine any of the sub-process models or sequence of sub-process models, or whether the process engineer or the sub-process engineer may need to add a sub-process model or a sequence of sub-process models. Refining a sub-process model may involve extending a sub-process model to include a set of other sub-process models, specifying the process flows among the latter sub-process models. Refining a sub-process model effectively deepens the level of granularity of the business process and creates a new process variant for the sub-process. If the business application detects any abnormality due to broken process flows or incorrect mapping of data fields between predecessor and successor sub-process models, the business process may alert the process engineer.

If any of the sub-process models gets refined or any additional sub-process model is needed in step 216, the process 200 loops back to step 202 and goes through steps 202 to 212. Every time a refinement is effected or a new sub-process model is added, a new process variant of the refined sub-process of the customer 114 is created and software artifacts corresponding to the newly created process variant are generated. Every new process variant and its corresponding software artifacts are stored in the repository 214, where they can be accessed during the runtime period. If no sub-process model refinement or no additional sub-process model is needed, the design of process variants and the design period may be considered complete in step 218.

In step 220, during a runtime period, the business application may receive from one or more of the users 112, who may collectively be referred to as a process execution user, a selection of one or more process variants among the plurality of process variants created and stored in the repository 214, during the design period. The process execution user may be responsible to execute or oversee the execution of one or more the sub-process of the business process.

In step 222, the business application may start executing the one or more process variants by dynamically combining the required software artifacts, which correspond to the process variants selected in step 220 and which were stored in the repository 214 during the design period. In other words, the business application does not need to execute all the process variants and different combinations of software artifacts stored in the repository 214. As a result, execution of the selected process variants and a particular combination of their corresponding software artifacts may remain as simple as possible, while adequately representing the business process to the level of granularity chosen by the process execution user. Execution of the runtime-relevant process variants and software artifacts may thus allow for more efficient use of processor resources and may reduce execution time. Moreover, side effects due to unused process variants and unused software artifacts are eliminated.

In step 224, during the runtime period, to start the business process, the business application may receive initial data from the process execution user, for example. The process execution user may enter such initial data in one or more business documents, also called business objects. The business objects may be stored on the customer 114 side, on one of the devices 116, or on the service provider side, either on the server 104 or in the database system 106. Alternatively, for an automated business process or sub-process, the data may be entered automatically by one or more processors or machines.

A sub-process model may be viewed as including an input object instance to receive input data needed to execute the tasks within the sub-process and an output object instance to store output data generated from the execution of the tasks. Although the sub-process models may consider the input data as being stored in the input object instance, the received input data may in fact be the output data from either the output object instance of a predecessor sub-process model or an initial business object of the business process. Consequently, during the runtime period, the input object instances may be completely virtualized, given that the input object instances may be mapped to output object instances of the predecessor sub-process models. Virtualization of the input object instances may further reduce computing resources and execution time.

In step 226, during the runtime period, the business application may validate the output object instance in which data was entered by the process execution user in step 224. The business application may interpret the process variants selected in step 220, from the repository 218, to trigger the right validations to be run. These validations may be based at least on the validity criteria and/or the format requirements specified by the process engineer and/or sub-process engineer in step 204 during the design time period. These validations may also ensure that the output data instance is valid for any successor sub-processes, as defined by the process variants selected in step 220. In other words, step 226 may also include validity checks for successor sub-processes.

In step 228, if the output object instance is found to be invalid, the process 200 may move to step 230, wherein the business application may transmit one or more alerts to the process execution user. The process execution user may thus be prompted to re-enter the data in the correct format for the output object instance in step 224. If the output object instance passes the validity check, the process 200 may proceed to step 232.

In step 232, the business application may write the output object instance as one of the business objects of the business process. The output object instance may be considered as a virtual input object instance to any successor sub-processes. Data from the output object instance may sometimes flow back to predecessor sub-processes. For example, the process execution user may trigger another sub-process that may need to be executed, before he can complete the task at hand.

In step 234, the business application may effectively transmit one or more tasks to be executed by the process execution user or automatically within one or more successor sub-processes by virtualizing the output object instance in step 232 into an input object instance for the one or more successor sub-processes. The business application may transmit one or more alerts to the process execution user whenever one or more tasks are ready to be executed.

In step 236, the one or more tasks may be executed by the process execution user or automatically. While the tasks are being executed, the process execution user may also update, through the user interfaces, the statuses of the tasks being executed. Alternatively, one or more processors or a machine may update the statuses for automated sub-processes. The business application may transmit, via the process flows, the status information to predecessor and successor sub-process models. Once the tasks executed, the business application may receive output data from the executed tasks in step 224, and repeat steps 226 through 234 until an instance of the business process of customer 114 may be completed.

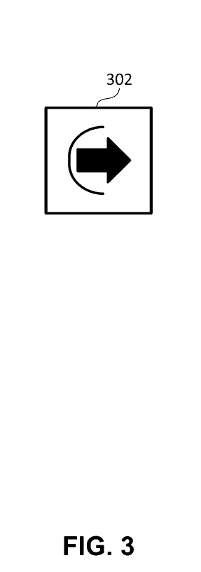

FIGS. 3-8 may help to put the process 200 into context, by referring to an exemplary business process of selling a product, and understand how the process 200 may be broken down into the design period and the runtime period. The selling process may begin with a sales order being placed by a buyer at the customer 114, for example. Sales order data, such as item number(s), quantity, price(s), the buyer's name and address, etc., may be recorded in an initial business document—a sales order business object, for example. As mentioned previously, the sales order data recorded in the sales order business object may be considered as output data (of a presumed sales order entry sub-process, for example), which in turn may be viewed as input data to one or more successor sub-process models.

During the design period, the process engineer may begin modeling the business process of customer 114 with an output object instance, shown as a selling process model 302 in FIG. 3, according to an embodiment. An output object instance may represent the most basic sub-process model or even a complete business process model. Thus, the selling process model 302 in FIG. 3 may also be considered as a first process variant of the selling process. The business application may generate software artifacts from this first process variant, and store both the first process variant and its corresponding software artifacts in the repository 214.

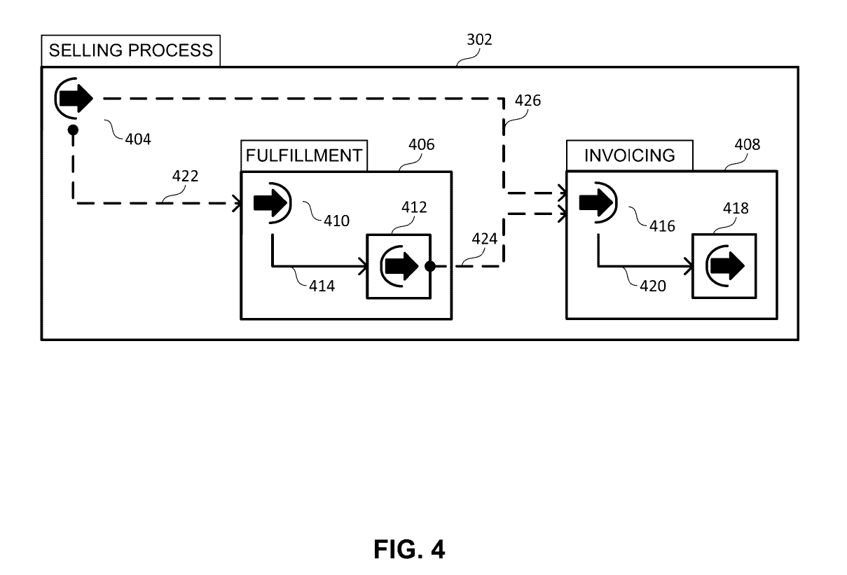

The goal of the customer 114, however, may be to fulfill the sales order and generate an invoice to be sent to the buyer. Therefore, according to an embodiment, FIG. 4 illustrates how the selling process model 302 may be extended during the design period. The selling process model 302 starts with a leading output object instance 404. The selling process model 302 may further include a fulfillment sub-process model 406 and an invoicing sub-process model 408, possibly selected by the process engineer from the library of standard sub-process models.

The fulfillment sub-process model 406 may include an input object instance 410 and an output object instance 412. A connection 414 between the input object instance 410 and the output object instance 412 represents the execution of the fulfillment sub-process, which may include picking, loading, and delivering the ordered item(s). Similarly, the invoicing sub-process model 408 may include an input object instance 416 and an output object instance 418. A connection 420 between the input object instance 416 and the output object instance 418 represents the execution of the invoicing sub-process, which may simply involve printing an invoice and sending it to the buyer.

In FIG. 4, connections 422, 424, and 426 may then be specified during the design period by the process engineer to represent process flows. The connections 422 and 424, with the leading dots, may represent instance-triggering process flows, while connection 426 may represent a data process flow. In other words, the invoicing sub-process model 408 may not be executed until the fulfillment sub-process model 406 has been executed and marked as completed.

At this point in the design period, a second process variant of the selling process has been created. The business application may proceed to generate software artifacts from this second process variant, and store both the second process variant and its corresponding software artifacts in the repository 214. Unless the process engineer and/or sub-process engineer need to refine one of the stored process variants or add any sub-process models, design process variants for the selling process may be considered complete.

During the runtime period, the business application may receive from the process execution user a selection between the first and the second process variants of the selling process. The business application may then dynamically combine the require software artifacts corresponding to the selected process variant.

If the first process variant of the selling process, as illustrated in FIG. 3, is selected by process execution user, the business application may provide the selling process model 302 with the initial sales order data entered in the sales order business object. At this point during the runtime period, the business application may only check the validity of the sales order business object, and no further tasks may be executed.

If the second process variant of the selling process, as illustrated in FIG. 4, is selected by the process execution user, the business application may enter the initial sales order data into the leading output object instance 404. The business application may then validate the output object instance 404 and, if valid, virtualize the output object instance 404 into the input object instance 410 of the fulfillment sub-process model 406. A process execution user responsible for executing the fulfillment sub-process may be alerted and provided with the data he needs via a user interface linked to the fulfillment sub-process model 406. The process execution user may update the status of the fulfillment sub-process 406, to “in process” for example. The process execution user may then proceed to pick, load, and deliver the ordered item(s). Once his task completed, the process execution user may update the status, to “finished” for example, and enter via the user interface output data pertinent to delivering the order item(s), such as quantity delivered, for the output object instance 412.

The business application may proceed to check the validity of the output object instance 412. If the output object instance 412 is not valid, the business application may alert the process execution user to re-enter the output data. If the output object instance 412 is valid, the business application may write the output object instance 412 as one of the business objects of the selling process, and virtualize the output object instance 412, along with sales order data from the leading output object instance 404, into the input object instance 416 of the invoicing sub-process model 408. A process execution user responsible for executing the invoicing sub-process may be alerted and provided with the data he needs via a user interface linked to the invoicing sub-process model 408. The process execution user may update the status of the invoicing sub-process 408, to “in process” for example. The process execution user may then proceed to print and send an invoice to the buyer. Once his task completed, the process execution user may update the status, to “finished” for example, and enter via the user interface output data pertinent to mailing the invoice, such as mailing date, for the output object instance 418.

The business application may proceed to check the validity of the output object instance 418. If the output object instance 418 is not valid, the business application may alert the process execution user to re-enter the output data. If the output object instance 418 is valid, the business application may write the output object instance 418 as one of the business objects of the selling process. At this point, given that there are no more sub-processes to be executed in the second process variant, this instance of the selling process model 302 may be considered completed.

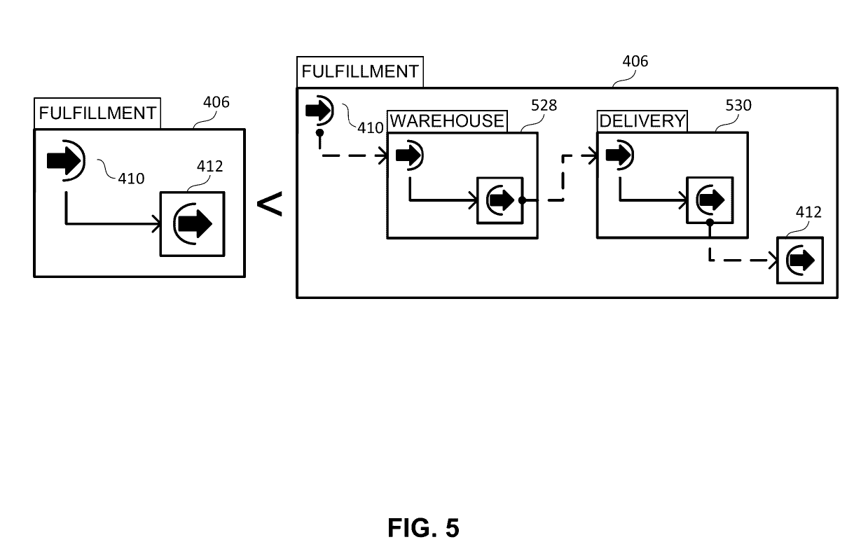

At some later point, to better monitor the selling process model 302, the customer 114 may choose, for example, to refine the fulfillment sub-process of FIG. 4 to include a warehouse sub-process, wherein picking and loading of ordered items take place, and a delivery sub-process. FIG. 5 illustrates, according to an embodiment, how a process engineer may model such a refinement during the design period. The fulfillment sub-process model 406 may be extended to include warehouse sub-process model 528 and delivery sub-process model 530. The warehouse sub-process model 528 and the delivery sub-process model 530 may be either selected from the library of standard sub-process models or created from scratch. The process engineer may further specify the process flows between the newly added warehouse sub-process model 528 and delivery sub-process model 530 and the existing input object instance 410 and output object instance 412.

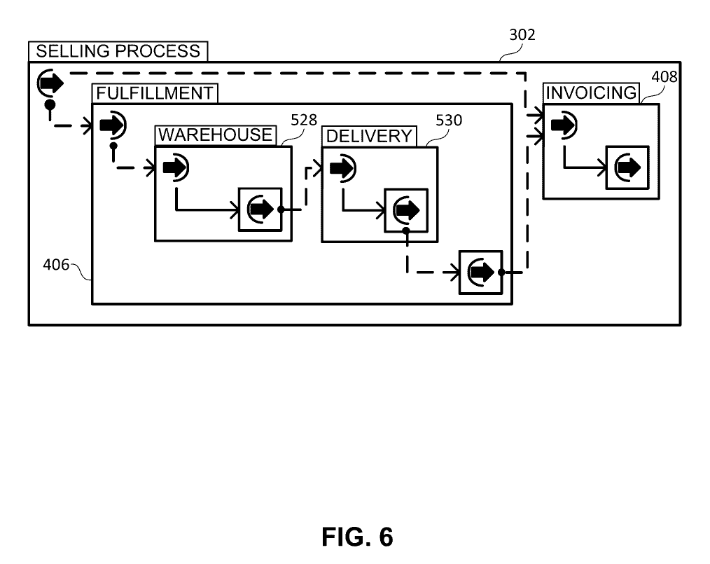

Once the process engineer finishes the refinement during the design period, a new process variant of the fulfillment sub-process has been created. The business application may proceed to generate software artifacts from this new process variant of the refined fulfillment sub-process, and store both the new process variant and its corresponding software artifacts in the repository 214. FIG. 6 illustrates how the new process variant of the refined fulfillment sub-process may be embedded into the process variant of the selling process illustrated in FIG. 4, by replacing the original process variant of the fulfillment process. Embedding the new process variant of the refined fulfillment sub-process automatically satisfies all the constraints, and uses the same interfaces as the original process variant of the fulfillment process. In FIG. 6, while the process variant of the fulfillment process has been changed, the process variant of the selling process remains unchanged.

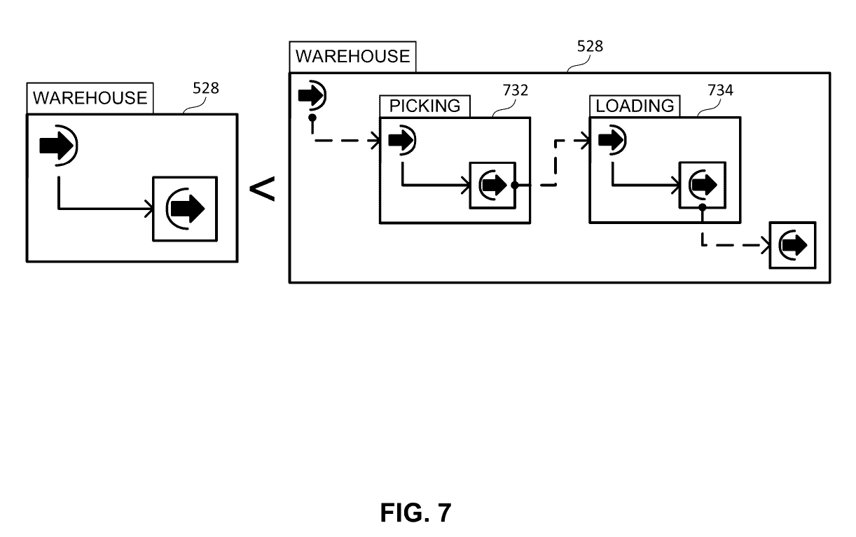

At some even later point, the customer 114 may further choose to refine the warehouse sub-process of FIG. 5 to include a picking sub-process and a loading sub-process. FIG. 7 illustrates, according to an embodiment, how a process engineer may model such a refinement during the design period. The warehouse sub-process model 528 may be extended to include picking sub-process model 732 and loading sub-process model 734. The picking sub-process model 732 and the loading sub-process model 734 may be either selected from the library of standard sub-process models or created from scratch. The process engineer may further specified the process flows between the newly added picking sub-process model 732 and loading sub-process model 734 and the input and output object instances of the warehouse sub-process model 528.

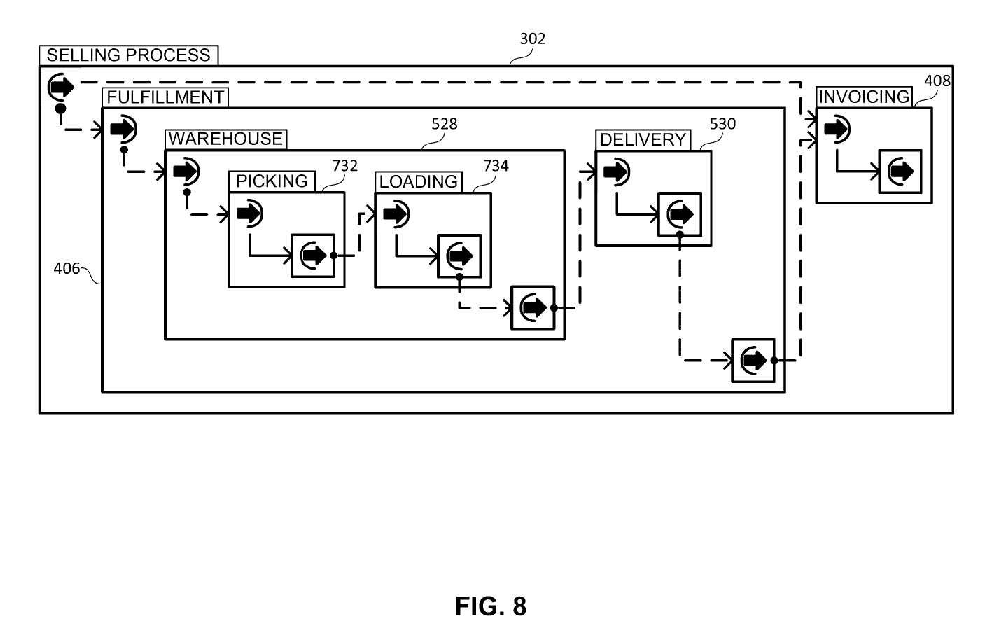

Once the process engineer finishes the refinement during the design period, a new process variant of the warehouse sub-process has been created. The business application may proceed to generate software artifacts from this new process variant of the refined warehouse sub-process, and store both the new process variant and its corresponding software artifacts in the repository 214. FIG. 8 illustrates how the new process variant of the refined warehouse sub-process may be embedded into the process variant of the refined fulfillment process of FIG. 5, by replacing the original process variant of the warehouse process. The fulfillment process may be embedded in the selling process in the same way as in FIG. 6. Embedding the new process variant of the refined warehouse sub-process automatically satisfies all the constraints, and uses the same interfaces as the original process variant of the warehouse process. In FIG. 8, while the process variant of the warehouse process has been changed, the process variant of the refined fulfillment process and the process variant of the selling process remain unchanged.

While the variants of the selling process shown in FIGS. 4, 6, and 8 accomplish the same goal, a customer is free to choose the level of granularity when modeling and running his business process. During the design period, the number of higher-level process variants may be kept manageable and, during the runtime period, the overall process may be made as complex as desired based on the level of granularity of the process variants. Regardless of the level of granularity, at runtime, the business application only considers and embeds the relevant process variants. Also, at runtime, regardless of the selected process variants, the input object instances are completely virtualized, given that the input object instances may be mapped to output object instances of the predecessor sub-process models. As a result, the generated code is tailored to the customer's desired level of granularity. Therefore, at runtime, no extra resources and execution time than required by the customer's tailored business process model are expensed.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

What is claimed is:

1. A method for executing a business process, comprising:
receiving a selection of a plurality of sub-process models corresponding to sub-processes of the business process, the plurality of sub-process models being selected from a library of standard sub-process models;
receiving user specifications for one or more of the sub-process models;
modifying the one or more of the sub-process models based on the user specifications;
linking the sub-process models to create one or more process variants and one or more process flows of the business process;
generating, by one or more processors, software artifacts from the process variants;
executing one or more of the process variants, by the one or more processors, by combining dynamically one or more of the software artifacts; and
triggering one or more of the sub-process models to receive data resulting from the corresponding sub-processes being executed.

2. The method of claim 1, wherein, for each of the one or more of the selected sub-process models, the user specifications include at least one of
a format required for the data,
validity criteria for the data, and
an algorithm needed to execute the sub-process model.

3. The method of claim 2, further comprising:
transmitting an alert to a user device when the data do not satisfy at least one of the format and the validity criteria.

4. The method of claim 1, wherein each process flow is one of an instance-triggering process flow and a data process flow, wherein
the instance-triggering process flow is a flow of data from a predecessor sub-process model to one or more successor sub-process models, such that execution of the one or more successor sub-process models can begin, and
the data process flow is a flow of additional data from at least one of an earlier sub-process model and a business object to one or more successor sub-process models.

5. The method of claim 1, further comprising:
including, in each process flow, status information about at least one of a predecessor sub-process model and a successor sub-process model.

6. The method of claim 1, further comprising:
refining at least one of the sub-process models by extending the sub-process model to include a set of linked sub-process models.

7. The method of claim 1, wherein each sub-process model is provided with a distinct user interface.

8. The method of claim 1, further comprising:
storing the data in one or more of a plurality of business objects.

9. The method of claim 8, wherein the data stored in the business objects can be input data to successor sub-process models.

10. The method of claim 1, wherein the created process variants and the generated software artifacts are stored in one of a database and a server.

11. A non-transitory machine-readable medium storing instructions adapted to be executed by one or more processors to perform operations comprising:
receiving a selection of a plurality of sub-process models corresponding to sub-processes of a business process, the plurality of sub-process models being selected from a library of standard sub-process models;
receiving user specifications for one or more of the sub-process models;
modifying the one or more of the sub-process models based on the user specifications;
linking the sub-process models to create one or more process variants and one or more process flows of the business process;
generating, by one or more processors, software artifacts from the process variants;
executing one or more of the process variants, by the one or more processors, by combining dynamically one or more of the software artifacts; and
triggering one or more of the sub-process models to receive data resulting from the corresponding sub-processes being executed.

12. The non-transitory machine-readable medium of claim 11, further comprising:
transmitting an alert to a user terminal when the data do not satisfy at least one of a data format and validity criteria.

13. The non-transitory machine-readable medium of claim 11, further comprising:
including, in each process flow, status information about at least one of a predecessor sub-process model and a successor sub-process model.

14. The non-transitory machine-readable medium of claim 11, further comprising:
refining at least one of the sub-process models by extending the sub-process model to include a set of linked sub-process models.

15. The non-transitory machine-readable medium of claim 11, further comprising:
storing the data in one or more of a plurality of business objects.

16. An electronic device, comprising:
one or more processors; and
memory storing instructions adapted to be executed by the one or more processors to perform operations comprising:
receiving a selection of a plurality of sub-process models corresponding to sub-processes of a business process, the plurality of sub-process models being selected from a library of standard sub-process models;
receiving user specifications for one or more of the sub-process models;
modifying the one or more of the sub-process models based on the user specifications;
linking the sub-process models to create one or more process variants and one or more process flows of the business process;
generating, by one or more processors, software artifacts from the process variants;
executing one or more of the process variants, by the one or more processors, by combining dynamically one or more of the software artifacts; and
triggering one or more of the sub-process models to receive data resulting from the corresponding sub-processes being executed.

17. The electronic device of claim 16, the operations further comprising:
transmitting an alert to a user terminal when the data do not satisfy at least one of a data format and validity criteria.

18. The electronic device of claim 16, the operations further comprising:
refining at least one of the sub-process models by extending the sub-process model to include a set of linked sub-process models.

19. The electronic device of claim 16, the operations further comprising:
storing the data in one or more of a plurality of business objects.

20. An electronic device comprising:
one or more processors; and
memory storing instructions adapted to be executed by the one or more processors to perform operations comprising:
receiving a selection of a plurality of sub-process models corresponding to sub-processes of a business process, the plurality of sub-process models being selected from a library of standard sub-process models;
receiving user specifications for one or more of the sub-process models;
modifying the one or more of the sub-process models based on the user specifications;
refining at least one of the sub-process models by extending the sub-process model to include a set of linked sub-process models;
linking the sub-process models to create one or more process variants and one or more process flows of the business process;
generating, by one or more processors, software artifacts from the process variants;
executing one or more of the process variants, by the one or more processors, by combining dynamically one or more of the software artifacts;
triggering one or more of the sub-process models to receive data resulting from the corresponding sub-processes being executed; and
storing the data in one or more of a plurality of business objects.
